(19) United States
(12) Patent Application Publication
(10) Pub. No.: US 2005/0128375 A1
(43) Pub. Date: Jun. 16, 2005

(54) Structure of a LCD screen lightguide panel

(76) Inventor: Jung-Yen Hsu, Xin-Ying City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/732,421

(22) Filed: Dec. 11, 2003

(51) Int. Cl. G02F 1/1335

(52) U.S. Cl. 349/61

(57) ABSTRACT

An improved structure of a LCD screen lightguide panel comprises an arc inlaid groove sunken in the lightguide panel to be in accordance with the outer diameter of the light source tube and set in the lower edge of a wedge-shaped or rectangular lead-light panel. The inlaid groove is used for inlaying the cooperated light source tube and fastening it in position. The way of light emitting from the circumference of the light source tube can be into the lightguide panel by direct transmission, reflection and reflection that achieves the improved device of the highlight flux.

### BACKGROUND OF THE INVENTION

1. Field of the Invention

The present invention relates to an improved structure of a LCD screen lightguide panel. Particularly, it relates to the light source tube in a poor light of a LCD screen set in an inlaid groove of the edge of the lightguide panel. Light from one or more than one tube can be into the lightguide panel by direct transmission, refraction and reflection that achieves the effect of the highlight flux.

2. Prior Art

According to the LCD screen using habitually, there are two categories of structures in the lightguide panel. As showing in FIG. 1, 2 and 3 the light source tube B(CCFL) in the structure of the first category is set in one side of the lightguide panel A, and light is in the way of casting from one side of the lightguide panel A(Side Edge Light). FIG. 1 shows the LCD screen lightguide panel A of a notebook computer is wedge-shaped. FIG. 2 shows the LCD screen lightguide panel A of a personal computer is rectangular. Both of lights coming from the side are more reflection rays or refraction rays but fewer direct rays; in addition, they have a fault in moving up and down in the lightguide panel A. The plural of the light source tubes B in the second category are set in the lower edge of the lightguide panel A and more of lights from them transmit directly into the lightguide panel A; thus, there are fewer faults in reflection and refraction.

### OBJECTS OF THE INVENTION

The primary purpose of the present invention is to solve the problem mentioned above in the structure of the lightguide panel using habitually and provide an improved structure of a LCD screen lightguide panel. The method is to set a sunken inlaid groove used for inlaying the light source tube inside in the lower edge of the lightguide panel in order to cooperate with the outer diameter of the light source tube (CCFL), whose lights not only transmit directly into the lightguide panel but also become refraction rays and reflection rays by transmitting from the side to achieve the effect of the highlight flux.

### BRIEF DESCRIPTION OF THE DRAWING

FIG. 1 is a perspective view showing the structure of a LCD screen lightguide panel of a notebook computer using habitually.

FIG. 2 is a perspective view showing the structure of a LCD screen lightguide panel of a personal computer using habitually.

FIG. 3 is a perspective view showing the structure of a LCD screen lightguide panel of a personal computer using habitually.

FIG. 4 is a view showing the structure of the lightguide panel in accordance with the present invention.

FIG. 5 is a perspective view showing the light source tube in action in one part of FIG. 4.

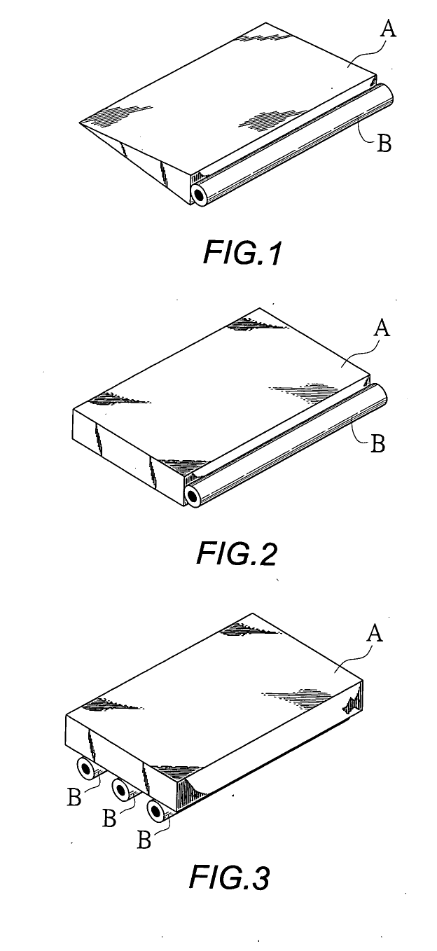

### DESCRIPTION OF THE REFERRED EMBODIMENT

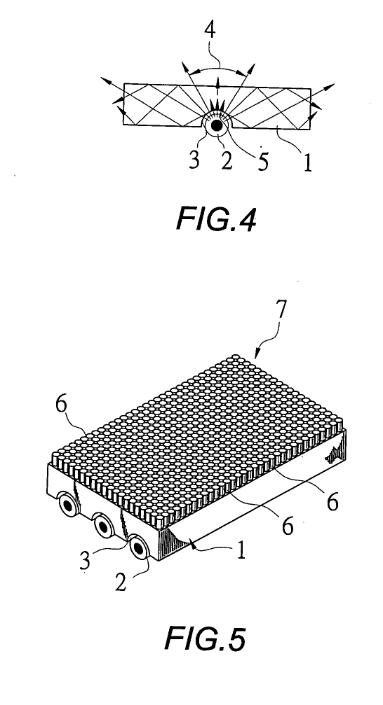

As showing in FIG. 4 and FIG. 5, the lightguide panel (1) is a wedge-shaped or rectangular light-transmission block and an arc inlaid groove (3) is sunken in the lower edge of the lightguide panel to be in accordance with the outer diameter of the light source tube (2). This inlaid groove (3) can be one or above one arc inlaid grooves (3) that are collimated and separated by suitable distances each other in order to inlay the same amount of the cooperated light source tube (2) and fasten it in position. Lights emitting everywhere from the circumference of the light source tube (2) not only transmit directly into the head (5) of the inlaid groove (3). As showing of the arrows (4), the lights among the ranges all transmit directly and both sides of the head (5) of the inlaid (3) become the way of casting from the side (Side Edge Light) to make light refract or reflect into the lightguide panel (1) that achieves the effect of the highlight flux.

1. An improved structure of a LCD screen lightguide panel, comprising:
a lightguide panel, formed of a wedge-shaped or rectangular light-transmission block has an arc inlaid groove sunken to be in accordance with the outer diameter of the light source tube in its lower edge;
a light source tube, the outer diameter is in accordance with the arc inlaid groove of said lightguide panel to inlay arc inlaid groove in the lower edge of said lightguide panel and fasten it in position.

2. An improved structure of a LCD screen lightguide panel according to claim 1, wherein the arc inlaid groove sunken in the lower edge of the lightguide panel can be one or more than one.

3. An improved structure of a LCD screen lightguide panel according to claim 2, wherein more than one arc inlaid grooves are installed to be collimated and separated by suitable distances each other.
